(19) United States
(12) Patent Application Publication
(10) Pub. No.: US 2020/0010714 A1
(43) Pub. Date: Jan. 9, 2020

(54) COATING COMPOSITION AND METHODS

(71) Applicants: Xiaobin WANG, Shanghai (CN); Weifeng DAI, Shanghai (CN); Xin LV, Shanghai (CN); Limin SHAO, Shanghai (CN); AKZO NOBEL COATINGS INTERNATIONAL B.V., Arnhem (NL)

(72) Inventors: Xiaobin WANG, Shanghai (CN); Weifeng DAI, Shanghai (CN); Xin LV, Shanghai (CN); Limin SHAO, Shanghai (CN)

(73) Assignee: Akzo Nobel Coatings International B.V., Arnhem (NL)

(21) Appl. No.: 16/480,892

(22) PCT Filed: Feb. 8, 2017
(86) PCT No.: PCT/CN2017/073097

§ 371 Date: Jul. 25, 2019

(51) Int. Cl. C09D 127/16; C09D 127/22

(52) U.S. Cl. CPC C09D 127/16; C09D 127/22

(57) ABSTRACT

Embodiments herein provide for a waterborne PVDF coating composition, the preparation method and use thereof. The coating composition includes a waterborne polyvinyl fluoride dispersion, a waterborne carboxyl acrylic resin, and a crosslinking agent. The resulting coating gives excellent film performance which is comparative to that of solvent borne PVDF formulations. Meanwhile, the coating composition requires smaller amount of crosslinking agent in the formulation, and lower heating temperature for curing process, as compared with solvent borne PVDF formulations.

### CROSS-REFERENCE TO RELATED APPLICATIONS

This is a national stage application under 35 U.S.C. § 371 of International Patent Application Serial No. PCT/CN2017/073097, entitled “A COATING COMPOSITION SYSTEM, THE PREPARATION METHOD THEREFORE AND THE USE THEREOF,” filed Feb. 8, 2017, the disclosure of which is hereby incorporated by reference herein in its entirety.

### FIELD OF THE TECHNOLOGY

Various embodiments herein relate to a fluoropolymer coating composition that is stable for storage and exhibits high physical strength and excellent chemical resistance upon curing. Specifically, the various embodiments herein relate to a waterborne polyvinyl fluoride coating composition, the preparation method and use thereof.

### BACKGROUND

Fluoropolymers are widely used as coating materials in outdoor construction field due to their excellent properties of stability, weathering resistance, chemical corrosion resistance and dirty resistance. Fluorocarbon coatings are known to provide good protection and decoration to constructions, such as maintaining gloss and color of the substrate material, and protecting the substrate material from corrosion during long term exposure to outdoor conditions.

Current high performance fluorocarbon coatings are mostly solvent based. There are two main types: 1. one package solvent borne polyvinylidene fluoride (PVDF) baking coating formulations; 2. two package solvent borne fluoroethylene vinyl ether (FEVE) air drying coating formulations. Both of the two types have been widely applied for pre-coating metal structure substrates such as large steel frame structure.

In recent years, the international standards and regulations on coatings have become more and more stringent. The use of environmentally unfriendly specific components, especially VOC (volatile organic compounds) components in coating formulations, will be limited. As a result, it is urged to develop waterborne fluorocarbon coating formulations as alternatives. So far there has been development of waterborne fluorocarbon coating formulations focusing on one package thermoplastic coatings. It includes waterborne fluorine modified acrylic coatings, waterborne FEVE fluorocarbon coatings, and waterborne PVDF coatings. These different types of fluorocarbon coatings are normally used on top of building surfaces. When they are used onto metal substrates, however, there is still a gap between waterborne and solvent borne coatings, especially in terms of the properties of film hardness, scratching resistance, and solvent resistance.

CN 101148553 disclosed a one package self-crosslinking system, wherein the waterborne anticorrosive metal coating mainly comprises aqueous fluorocarbon resin, pure acrylic emulsion, organic silicone emulsion and adipic acid hydrazide. CN 103788783 disclosed a self-crosslinking fluorine acrylic polymer modified by silane crosslinking agent, wherein the waterborne fluorocarbon paint mainly comprises aqueous fluorocarbon emulsion and siloxane crosslinking agent. Although the above mentioned coatings involve crosslinking mechanism, the crosslinking density is low, and the performance of the resulting coating is not as good as that of solvent borne coatings.

CN 104119738 disclosed a two package waterborne thermosetting anticorrosive fluorocarbon coating, in which the component A mainly comprises waterborne fluorocarbon resin and component B mainly comprises waterborne isocyanate. The coating is based on a two package air drying system, wherein hydroxyl group functionalized FEVE dispersion resin is used as the fluorocarbon material, and isocyanate is used as the cross-linking agent. The main purpose of the coating is to prevent the substrate from corrosion. However, the pot life of this two package coating is relatively short, leading to difficulties in storage, transportation and application. CN 103059664 disclosed a one package cross-linking system, wherein a fluorocarbon resin and an acrylic resin are used as binders; a blocked isocyanate and melamine are used as crosslinking agents. The resulting coating is mainly applied on the backer film of solar cells. Due to the large amount of crosslinking agents contained in the formulation, the weathering resistance and humidity resistance of the resulting coating film are limited. Therefore, it is not suitable for use as a high performance water-borne fluorocarbon coating.

As such, it would be desirable to provide a waterborne PVDF coating composition that exhibits good storage stability, and may form a coating with satisfying pencil hardness and gloss.

### SUMMARY

Aspects herein related to a coating composition. The coating composition can include a waterborne polyvinyl fluoride dispersion selected from one or more of PVDF homopolymer dispersions and acrylic modified PVDF polymer dispersions, where if the waterborne polyvinyl fluoride dispersion is a PVDF homopolymer dispersion, the composition also comprises a waterborne carboxyl acrylic resin, and a crosslinking agent.

In an embodiment, the coating composition can include 20 to 80 parts by solid weight of a waterborne polyvinyl fluoride dispersion selected from one or more of PVDF homopolymer dispersions, 5 to 60 parts by weight of a waterborne carboxyl acrylic resin, and 1 to 20 parts by weight of a crosslinking agent, based on 100 parts by weight of total solid content.

In an embodiment, the coating composition can include a ratio between the solid weight of waterborne polyvinyl fluoride dispersion and the total solid weight of waterborne carboxyl acrylic resin and crosslinking agent is not less than 7:3.

In an embodiment, the coating composition can include a solid weight ratio between the waterborne carboxyl acrylic resin and the crosslinking agent is from 100:1 to 10:3.

In an embodiment, the coating composition can include 20 to 80 parts by solid weight of a waterborne polyvinyl fluoride dispersion selected from one or more of acrylic modified PVDF polymer dispersions and 1 to 20 parts by weight of a crosslinking agent, based on 100 parts by weight of total solid content.

In an embodiment, the coating composition can include a ratio between the solid weight of waterborne polyvinyl fluoride dispersion and the solid weight of crosslinking agent that is not less than 7:3.

In an embodiment, the coating composition can include a crosslinking agent selected from amino resins, epoxy silanes, and blocked isocyanates.

In an embodiment, the amino resins can be selected from highly methylated melamines, partially methylated melamines, methylated high imino melamines, and butylated melamines

In an embodiment, a method for preparing a coating composition is provided. The method can include a step of mixing a waterborne polyvinyl fluoride dispersion selected from one or more of PVDF homopolymer dispersions and acrylic modified PVDF polymer dispersions, where if the waterborne polyvinyl fluoride dispersion is a PVDF homopolymer dispersions, the method further comprises a step of mixing a waterborne carboxyl acrylic resin into the composition, and a crosslinking agent.

In an embodiment, the method can further include a step of mixing 20 to 80 parts by solid weight of a waterborne polyvinyl fluoride dispersion selected from one or more of PVDF homopolymer dispersions, 5 to 60 parts by weight of a waterborne carboxyl acrylic resin, and 1 to 20 parts by weight of a crosslinking agent, based on 100 parts by weight of total solid content.

In an embodiment, the method can further include a step of mixing 20 to 80 parts by solid weight of a waterborne polyvinyl fluoride dispersion selected from one or more of acrylic modified PVDF polymer dispersions, and 1 to 20 parts by weight of a crosslinking agent, based on 100 parts by weight of total solid content.

In an embodiment, the use of the coating composition can include forming a coating on a substrate of aluminum, steel, anodized aluminum oxide, or aluminum-magnesium alloy.

In an embodiment, a coated substrate is provided.

### BRIEF DESCRIPTION OF THE FIGURES

The above and other objectives, features and advantages of the various embodiments herein will become more apparent to those of ordinary skill in the art by describing in embodiments thereof with reference to the accompanying drawings.

FIG. 1 shows the coating surface of example 2 in the humidity resistance test after 4000 hours.

FIG. 2 shows the coating surface of the comparative example in the humidity resistance test after 250 hours.

### DETAILED DESCRIPTION

The various embodiments herein provide for a waterborne PVDF coating compositions that has a relatively long pot life for storage and transportation, and exhibit high physical strength and excellent chemical resistance upon curing. The various embodiments herein also provide for the preparation method and use of the coating composition.

In one aspect, a one package coating composition is provided. The coating composition mainly includes:
a waterborne polyvinyl fluoride dispersion selected from one or more of PVDF homopolymer dispersions and acrylic modified PVDF polymer dispersions,
if the waterborne polyvinyl fluoride dispersion is a PVDF homopolymer dispersion, the composition also comprises a waterborne carboxyl acrylic resin, and
a crosslinking agent.

As used herein, the term “waterborne polyvinyl fluoride dispersion” involves both PVDF homopolymer dispersions and acrylic modified PVDF polymer dispersions. Typically the homopolymer or polymer has an average molecule weight of not less than 10,000, not less than 400,000, and meanwhile the average molecule weight is not greater than 1000,000, or not greater than 500,000.

It should be noticed that in practice vinylidene fluoride may be polymerized with a small amount of one or more other monomers such as trifluoroethylene, tetrafluoroethylene, dichloroethylene, trichloroethylene, tetrachloroethylene, chlorotrifluoroethylene, etc., to obtain PVDF homopolymer based polymers. Such prepared polymers have similar chemical and physical properties as that of pure PVDF homopolymers, and therefore are also suitable for use herein as the polyvinyl fluoride dispersion. In a broad sense, PVDF homopolymers according to the various embodiments herein are meant to include pure PVDF homopolymers and polymers prepared by polymerizing vinylidene fluoride and a small amount of one or more other monomers. Specifically, for example, the PVDF homopolymers according to the various embodiments herein are prepared with over 85 wt. %, over 90 wt. %, or over 95 wt. % of vinylidene fluoride based on the total weight of monomers. The average particle size of such prepared PVDF homopolymers that are suitable for use in the various embodiments herein are from 20 nm to 10 μm, from 100 nm to 5μm, or from 200 nm to 2μm. The solid content of the PVDF homopolymer dispersions is from 5 wt. % to 65 wt. %, from 20 wt. % to 50 wt. %, or from 40 wt. % to 50 wt. %. The pH value of the PVDF homopolymer dispersions is in the range from 2 to 12, from 4 to 10, or from 5 to 8.

Acrylic modified PVDF polymers according to the various embodiments herein are mixtures of PVDF and one or more acrylic polymers on a micro-molecular scale. They are prepared by emulsion polymerizing vinylidene fluoride, and subsequently dispersing and polymerizing acrylic monomers in the emulsion during PVDF polymerization. Suitable acrylic monomers are selected from, but not limited to, acrylic acid, methacrylic acid, methyl acrylate, methyl methacrylate, acrylic amide, methacrylic acid amide, etc. In various embodiments, the weight ratio between PVDF and acrylic polymers is from 70:30 to 50:50. The particle size of the acrylic modified PVDF polymers is from 20 nm to 10 μm, from 100 nm to 5μm, or from 200 nm to 2 μm. The solid content of the acrylic modified PVDF polymer dispersions is from 5 wt. % to 65 wt. %, from 20 wt. % to 50 wt. %, or from 40 wt. % to 50 wt. %. The pH value of the acrylic modified PVDF polymer dispersions is in the range from 2 to 12, from 4 to 10, or from 5 to 8.

The ratio of the solid weight of the waterborne polyvinyl fluoride dispersion in the composition according to the various embodiments herein is not less than 20 parts by weight, not less than 40 parts by weight, or not less than 50 parts by weight, based on 100 parts by weight of the total solid content of the composition, and meanwhile, the ratio of the solid weight of the waterborne polyvinyl fluoride dispersion is not greater than 80 parts by weight, not greater than 60 parts by weight, or not greater than 55 parts by weight, based on 100 parts by weight of the total solid content of the composition.

When a PVDF homopolymer as discussed above is used as the waterborne polyvinyl fluoride dispersion, the composition may further include a waterborne carboxyl acrylic resin to improve the crosslinking density of the resulting coating. When used herein, the term “waterborne carboxyl acrylic resin” involves both a carboxyl acrylic latex and a water soluble carboxyl acrylic resin. The carboxyl functional groups of said carboxyl acrylic latex and water soluble carboxyl acrylic resin are capable of reacting with cross-linking agents to increase the crosslinking density of the resulting coating. It has been observed that the addition of such a carboxyl acrylic latex and/or a water soluble carboxyl acrylic resin helped to improve the physical and chemical properties of the resulting coating, such as film hardness, adhesion, and chemical resistance, etc.

Typically, carboxyl acrylic latexes that are suitable for use in the various embodiments herein have an acid value of 10 to 150 mg KOH/g, a particle size of from 20 nm to 10 μm, from 100 nm to 5μm, or from 500 nm to 2μm, and a solid content of from 5 wt. % to 80 wt. %, from 20 wt. % to 60 wt. %, or from 45 wt. % to 55 wt. %. Water soluble carboxyl acrylic resins that are suitable for use have an acid value of 10 to 150 mg KOH/g, a molecular weight of 10000 to 100000, a solid content of from 5 wt. % to 65 wt. %, from 20 wt. % to 50 wt. %, and or from 40 wt. % to 50 wt. %.

The weight ratio of the waterborne carboxyl acrylic resin in the composition according to the various embodiments herein is not less than 5 parts by weight, not less than 10 parts by weight, or not less than 15 parts by weight, based on 100 parts by weight of the total solid content of the composition, and meanwhile, the weight ratio of the waterborne carboxyl acrylic resin is not greater than 60 parts by weight, not greater than 40 parts by weight, or not greater than 20 parts by weight, based on 100 parts by weight of total solid content of the composition. To ensure a relatively high crosslinking density and thus to increase the water and solvent resistance performance of the resulting coating, the solid content weight ratio between the waterborne carboxyl acrylic resin and the crosslinking agent is from 100:1 to 10:3.

The crosslinking agent is selected from blocked isocyanates, amino resins, and epoxy silanes. Said blocked isocyanate is a chemically modified isocyanate which has a blocking group introduced into its molecule structure. With the protection of the blocking group, the isocyanate functional group is normally stable at room temperature. When heated to a temperature of about 120° C. to 200° C., the blocking group may be dissociated to regenerate the isocyanate functional group. The unblocked isocyanate is then capable of reacting with hydroxyl-containing compounds to form thermally stable urethane or urea linkages. Typical blocked isocyanates are hexamethylene diisocyanate (HDI) and 3-isocyanatomethyl-3, 5, 5-trimethylcyclohexyl isocyanate (IPDI) with the blocking groups selected from phenol, thiophenol, alcohol, mercaptan, oxime, amide, imide, pyrazole, etc. Amino resins suitable for use herein are melamine resins, benzoguanamine resins and urea resins. In various embodiments, the melamine resins are functionalized melamines selected from highly methylated melamines, partially methylated melamines, methylated high imino melamines, and butylated melamines Epoxy silanes suitable for use herein are silanes with epoxy functional group. Typical epoxy silanes are 3-glycidoxypropyl methyldimethoxysilane, 3-glycidoxypropyl trimethoxysilane, 3-glycidoxypropyl methyldiethoxysilane, 3-glycidoxypropyl triethoxysilane, 2-(3,4 epoxycyclohexyl) ethyltrimethoxysilane, etc. As an example, the crosslinking agent suitable for use herein is epoxy silane commercially available from Evonik under the trade name Dynasylan Glyeo.

According to one embodiment, a one single crosslinking agent selected from blocked isocyanates, amino resins, and epoxy silanes is used in the composition. It has been observed that the single crosslinking agent resulted in satisfying physical and chemical properties of the coating, specifically in terms of adhesion to the substrate after UV aging and humidity aging tests, and the uniformity of the coating surface after humidity aging test.

The weight ratio of the crosslinking agent is not less than 1 part by weight, 3 parts, or 5 parts, based on 100 parts by weight of total solid content, and meanwhile, the weight ratio of the crosslinking agent is not greater than 20 parts by weight, 15 parts, or 10 parts, based on 100 parts by weight of total solid content.

When a PVDF homopolymer dispersion as discussed above is used as the waterborne polyvinyl fluoride dispersion, the ratio between the solid weight of waterborne polyvinyl fluoride dispersion and the total solid weight of waterborne carboxyl acrylic resin and crosslinking agent is not less than 7:3, and when an acrylic modified PVDF polymer dispersion as discussed above is used as the waterborne polyvinyl fluoride dispersion, the ratio between the solid weight of waterborne polyvinyl fluoride dispersion and crosslinking agent is not less than 7:3, so as to ensure a good weathering resistance performance of the resulting coating.

In another aspect of the various embodiments herein, a method for preparing the coating composition is provided.

The waterborne polyvinyl fluoride dispersion for use in the composition of the various embodiments herein can be either prepared from vinylidene fluoride with or without other monomers as discussed above, by using conventional emulsion polymerization technology, or readily available from commercial manufacturers. As an example, PVDF homopolymers suitable for use herein are commercially available from Zhonghao Chenguang Research Institute of Chemical Industry under the trade name CG-E50. As another example, acrylic modified PVDF polymers suitable for use herein are commercially available from Akema under the trade name CRX.

The waterborne carboxyl acrylic resin for use in the composition of the various embodiments herein is either prepared by conventional processes such as radical polymerization of acrylic ester monomers followed by carboxylation, or readily available from commercial manufacturers. As an example, carboxyl acrylic latexes suitable for use herein are commercially available from DSM under the trade name B 890.

When the waterborne polyvinyl fluoride dispersion is a PVDF homopolymer dispersion, the method for preparing the coating composition according to the various embodiments herein mainly comprises the step of mixing the PVDF homopolymer dispersion, the waterborne carboxyl acrylic resin and the crosslinking agent in sequence as per the weight ratio discussed above. When the waterborne polyvinyl fluoride dispersion is an acrylic modified PVDF polymer dispersion, the method mainly comprises the step of mixing the waterborne polyvinyl fluoride dispersion and the crosslinking agent in sequence as per the weight ratio discussed above.

Besides the main components, the composition of the various embodiments herein may also comprise other ingredients that are commonly used in the prior art. For example, a mill base is often required to provide the resulting coating with desired colors and other properties for practical use. Other components such as pH regulator, de-foam agent, coalescent, thickening agent, etc., may also be added into the composition for respective purposes. The choice of these additional components will not be discussed here in detail, as they have been in common use already.

According to still another aspect of the various embodiments herein, it further provides the use of the coating composition to form a coating on the substrate of aluminum, steel, anodized aluminum oxide (AAO), aluminum-magnesium alloy, etc.

The coating composition according to the various embodiments herein provides excellent film performance which is comparative to that of solvent borne PVDF formulations, and better pencil hardness and higher gloss of the resulting film. Meanwhile, the coating composition according to the various embodiments herein requires smaller amount of crosslinking agent in the formulation, and lower heating temperature for curing process, as compared with solvent borne formulations, thus helps cost control in practice.

### EXAMPLES

The following examples are offered to illustrate, but not to limit the various embodiments herein.

### Raw Materials

Acrylic modified PVDF polymer: Hylar XPH-858 (available from Solvay)

Carboxyl acrylic latex: AC 2508 (available from Alberdingk)

Water soluble carboxyl acrylic resin: Neocryl B 817 (available from DSM)

PVDF homopolymer: Hylar XPH-857-3 (available from Solvay)

Melamine: Cymel 303 (available from Cytec)

Epoxy silane: Dynasylan Glymo (available from Evonik)

Blocked isocyanate: Bayhydur BL XP 2706(available from Bayer)

Dispersion gent: BYK 190 (available from BYK)

De-foam agent: BYK 011 (available from BYK)

Wetting agent: Triton CF10 surfactant (available from Dow)

TiO₂: CR-880 (available from Tronox)

pH regulator: Dimethyl ethanol amine (available from Dow)

Thickening agent: Acrysol RM-8W (available from Dow)

### Example 1

### (1) TiO₂ Mill Base Preparation

In a stainless steel beaker equipped with Cowles blade disperser and a water cooling bath, 64.8 g deionized water was charged firstly, then 1.69 g dispersion agent (BYK 190), 3.5 g wetting agent (Triton CF-10 Surfactant), 0.26 g pH regulator (dimethyl ethanol amine) and 0.43 g de-foam agent (BYK 011) were slowly added in sequence under stirring. After fully mixing, 100 g TiO₂ (Tronox CR-880) was added and dispersed at 2000 RPM for 10 minutes. Then 150 g zirconium beads (1.5-2.5 mm) were added and the mixture was stirred at 2000 RPM until the Hegman fineness achieved 7 HS. The zirconium beads were then filtered out and the mill base was transferred to a plastic container for use.

### (2) PVDF Coating Composition Preparation

In a stainless steel beaker equipped with Cowles blade disperser and a water cooling bath, 390 g PVDF homopolymers (Hylar XPH 857-3) and 128.58 g water soluble carboxyl acrylic resin(Neocryl B 817) were added in sequence under slow stirring. 3.31 g pH regulator (dimethyl ethanol amine) was added drop-wise into the mixture to adjust pH value to the range of 8.5-9.5.

Then, 19.29 g melamine (Cymel 303) was added under slow stirring. 1.79 g wetting agent (Triton CF 10 Surfactant), 7.18 g dispersion agent (BYK 190) and 1.79 g de-foam agent (BYK 011) were added into the above mixture separately. After mixing 30 minutes, 139.29 g TiO₂ mill base prepared in step (1) was added under agitation. Then, 19.5 g coalescent which is the mixture of propylene glycol methyl ether, dipropylene glycol methyl ether and tripropylene glycol methyl ether, and 21 g deionized water were added slowly under agitation. Afterwards, 7.16 g thickening agent (Acrysol RM-8W) was added to adjust the paint viscosity to 55-65 KU tested by Krebs Viscometer (Krebs 480).

### (3) Application of the Coating Composition

The coating composition was applied onto a substrate of Aluminum, heated to a temperature of 180° C. and maintained for 10 minutes to form a coating.

### Example 2

### (1) TiO₂ Mill Base Preparation

In a stainless steel beaker equipped with Cowles blade disperser and a water cooling bath, 32.4 g deionized water was charged firstly, then 4.15 g dispersion agent (BYK 190), 1.75 g wetting agent (Triton CF-10 Surfactant), 0.13 g pH regulator (dimethyl ethanol amine) and 0.38 g de-foam agent (BYK 011) were added slowly in sequence under stirring. After fully mixing, 50 g TiO₂ (Tronox CR-880) was added slowly and dispersed at 2000 RPM for 10 minutes. Then, 75 g zirconium beads (1.5-2.5 mm) were added and the mixture was stirred at 2000 RPM until the Hegman fineness achieves 7 HS. The zirconium beads were then filtered out and the mill base was transferred to a plastic container for use.

### (2) PVDF Coating Composition Preparation

In a stainless steel beaker equipped with Cowles blade disperser and a water cooling bath, 418.58 g acrylic modified PVDF polymer (Hylar XPH-858) was added. Afterwards, 0.12 g pH regulator (dimethyl ethanol amine) was added drop-wise into the mixture to adjust pH value to 8.5-9.5. Then 19.29 g melamine (Cymel 303) was added under slow stirring. 1.43 g de-foam agent (BYK 011) was added into the above mixture. After mixing 30 minutes, 95.24 g TiO₂ mill base prepared in step (1) was added slowly under agitation. Then, 19.5 g coalescent which is the mixture of propylene glycol methyl ether, dipropylene glycol methyl ether and tripropylene glycol methyl ether, and 21 g deionized water were added slowly under agitation. Afterwards, 7.16 g thickening agent (Acrysol RM-8W) was added to adjust the paint viscosity to 55-65 KU by Krebs Viscometer (Krebs 480).

### (3) Application of the Coating Composition

The coating composition was applied onto a substrate of Aluminum, heated to a temperature of 180° C. and maintained for 10 minutes to form a coating.

### Example 3

### (1) TiO₂ Mill Base Preparation

In a stainless steel beaker equipped with Cowles blade disperser and a water cooling bath, 32.4 g deionized water was charged firstly, then 4.15 g dispersion agent (BYK 190), 1.75 g wetting agent (Triton CF-10 Surfactant), 0.13 g pH regulator (dimethyl ethanol amine) and 0.38 g de-foam agent (BYK 011) were added slowly in sequence under stirring. After fully mixing, 50 g TiO₂ (Tronox CR-880) was added slowly and dispersed at 2000 RPM for 10 minutes. Then 75 g zirconium beads (1.5-2.5 mm) were added and the mixture was stirred at 2000 RPM until the Hegman fineness achieves 7 HS. The zirconium beads were then filtered out and the mill base was transferred to a plastic container for use.

### (2) PVDF Coating Composition Preparation

In a stainless steel beaker equipped with Cowles blade disperser and a water cooling bath, 418.58 g acrylic modified PVDF polymer (Hylar XPH-858) was added. Afterwards, 0.12 g pH regulator (dimethyl ethanol amine) was added drop-wise into the mixture to adjust pH value to 8.5-9.5. Then 5.6 g epoxy silane (Dynasylan glymo) was added under slow stirring. 1.43 g de-foam agent (BYK 011) was added into the above mixture. After mixing 30 minutes, 95.24 g TiO₂ mill base prepared in step (1) was added slowly under agitation. Then, 19.5 g coalescent which is the mixture of propylene glycol methyl ether, dipropylene glycol methyl ether and tripropylene glycol methyl ether, and 21 g deionized water were added slowly under agitation. Afterwards, 7.16 g thickening agent (Acrysol RM-8W) was added to adjust the paint viscosity to 55-65 KU by Krebs Viscometer (Krebs 480).

### (3) Application of the Coating Composition

The coating composition was applied onto a substrate of Aluminum, heated to a temperature of 180° C. and maintained for 10 minutes to form a coating.

### Example 4

### (1) TiO₂ Mill Base Preparation

In a stainless steel beaker equipped with Cowles blade disperser and a water cooling bath, 64.8 g deionized water was charged firstly, then 1.69 g dispersion agent (BYK 190), 3.5 g wetting agent (Triton CF-10 Surfactant), 0.26 g pH regulator (dimethyl ethanol amine) and 0.43 g BYK 011 were added slowly in sequence under stirring. After fully mixing, 100 g TiO₂ was added slowly and dispersed at 2000 RPM for 10 minutes. Then 150 g zirconium beads (1.5-2.5 mm) were added and the mixture was stirred at 2000 RPM until the Hegman fineness achieved 7 HS. The zirconium beads were then filtered out and the mill base was transferred to a plastic container for use.

### (2) PVDF Coating Composition Preparation

In a stainless steel beaker equipped with Cowles blade disperser and a water cooling bath, 390 g PVDF homopolymer (Hylar XPH 857-3) and 128.58 g carboxyl acrylic latex were added in sequence under slow stirring. 3.31 g pH regulator (dimethyl ethanol amine) was added drop-wise into the mixture to adjust pH value to the range of 8.5-9.5. Then, 7.26 g epoxy silane (Dynasylan glymo) was added under slow stirring. And 1.79 g wetting agent (Triton CF 10 Surfactant), 7.18 g dispersion agent (BYK 190), 1.79 g de-foam agent (BYK 011) were added into the above mixture separately. After mixing 30 min, 139.29 g TiO₂ mill base (1) was added under agitation. Then, 19.5 g coalescent which is the mixture of propylene glycol methyl ether, dipropylene glycol methyl ether and tripropylene glycol methyl ether, and 21 g deionized water were added slowly under agitation. Afterwards, 7.16 g thickening agent (Acrysol RM-8W) was added to adjust viscosity to 55-65 KU by Krebs Viscometer (Krebs 480).

### (3) Application of the Coating Composition

The coating composition was applied onto a substrate of Aluminum, heated to a temperature of 180° C. and maintained for 10 minutes to form a coating.

### Example 5: Comparative Example

### (1) TiO₂ Mill Base Preparation

In a stainless steel beaker equipped with Cowles blade disperser and a water cooling bath, 32.4 g deionized water was charged firstly, then 4.15 g dispersion agent (BYK 190), 1.75 g wetting agent (Triton CF-10 Surfactant), 0.13 g pH regulator (dimethyl ethanol amine) and 0.38 g de-foam agent (BYK 011) were added slowly in sequence under stirring. After fully mixing, 50 g TiO₂ was added slowly and dispersed at 2000 RPM for 10 minutes. Then 75 g zirconium beads (1.5-2.5 mm) were added and the mixture was stirred at 2000 RPM until the Hegman fineness achieves 7 HS. The zirconium beads were then filtered out and the mill base was transferred to a plastic container for use.

### (2) PVDF Coating Composition Preparation

In a stainless steel beaker equipped with Cowles blade disperser and a water cooling bath, 140 g acrylic modified PVDF polymer (Hylar XPH 858) was added. 0.03 g pH regulator (dimethyl ethanol amine) was added drop-wise into the mixture to adjust pH value to 8.5-9.5. Then 60 g blocked isocyanate (Bayhydur BL XP 2706) and 5 g melamine (Cymel 303) were added under slow stirring (300 RPM). 0.79 g de-foam agent (BYK 011) was added into the above mixture. After mixing evenly, 54 g TiO₂mill base prepared in step (1) was added slowly under agitation for 30 minutes. Afterwards, 1 g dipropylene glycol methyl ether was added into the mixture slowly under agitation.

### (3) Application of the Coating Composition

The coating composition was applied onto a substrate of Aluminum, heated to a temperature of 180° C. and maintained for 10 minutes to form a coating.

The coating compositions prepared in the examples 1, 2, 3, 4 and the comparable example are tested according to following methods:

### Gloss

The gloss is measured by using a Sheen Tri-Glossmaster at 60° geometry according to ASTM D523.

### MEK Resistance

MEK resistance test is evaluated according to ASTM D4572. The MEK resistance is characterized with the number of Taber cycles required for the coating to wear a way to the substrate.

### Dry Film Hardness

Dry film hardness is measured by using a pencil of Berol Eagle Turquoise or equivalent (grade F minimum hardness) according to ASTM D3363.

### Adhesion

The adhesion is evaluated using crosshatched method according to ASTM D3359 by applying and removing pressure-sensitive tape over cuts made in the film, and the tape used is 3M Scotch 600. The adhesion ability is characterized with the percentage of square taping off.

### Impact Resistance

The impact resistance was evaluated according to AAMA 2605. The equipment is Gardner impact tester with a 16 mm diameter round-nosed impact tester 18 N-m range. And the tape used for testing is Scotch 600 produced by 3M. The impact resistance ability is characterized by the percentage of area taped off.

### Nitric Acid Resistance

The nitric acid resistance is conducted per AAMA 2605. Nitric acid is purchased from local supplier with 70% ACS reagent grade. The nitric acid resistance is characterized with the color change between exposed areas and unexposed.

### Cleveland Test

Cleveland test is used for evaluating humidity resistance of film. The Cleveland test was measured according to ASTMD4585, by exposing samples in a controlled heat-and-humidity cabinet for 4,000 hours at 38° C. Test panels are evaluated for every 250 hours, and test results are characterized with blister's size and density.

### Cyclic Corrosion Testing

The cyclic test is conducted according to ASTM G85, Annex AS-dilute electrolyte cyclic fog/dry test under weak acid condition. The panels are exposed in the cabinet for 2000 hours, and evaluated at every 250 hours intervals.

### QUVB Test

The QUVB test is conducted according to ASTM G154. The test conditions are UV light for 4 hours at 60° C. and then condensation for 4 hours at 50° C. cycle. The sample is exposed in the QUVB cabinet for 4000 hours, and evaluated for every 250 hours. Test results are characterized with film gloss, chalking and color change.

TABLE 1
Experiment Results

| No. | Test Item | E-1 | E-2 | E-3 | E-4 | CE |
|---|---|---|---|---|---|---|
| 1 | Dry Film Hardness | F | F | F | F | F |
| 2 | Film Adhesion | Pass | Pass | Pass | Pass | Pass |
| 3 | Impact Resistance | Pass | Pass | Pass | Pass | Pass |
| 4 | Nitric Acid | 0.9 ΔE | 2.1 ΔE | 1.2 ΔE | 1.5 ΔE | 1.8 ΔE |
| | Resistance | | | | | |
| 5 | MEK Resistance | >200 DR | >200 DR | >200 DR | >200 DR | >200 DR |
| 6 | QUVB | Pass | Pass | Pass | Pass | Pass |
| 7 | Cleveland Test | Pass | Pass | Pass | Pass | Fail |
| 8 | Cyclic | Pass | Pass | Pass | Pass | Pass |
| | Corrosion | | | | | |
| | Testing (CRH) | | | | | |

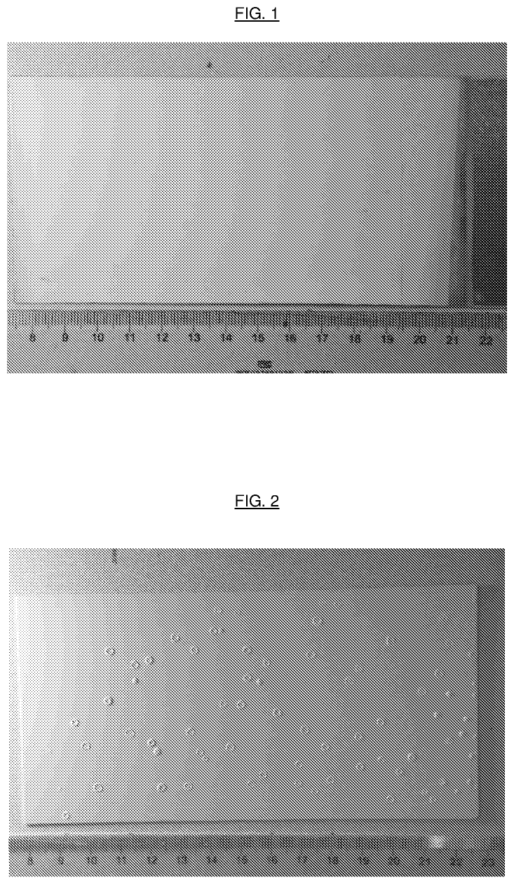

The testing results show that the coating composition of the various embodiments herein exhibited outstanding performance in terms of dry film hardness, film adhesion, impact resistance, nitric acid resistance, MEK resistance, QUVB, Cleveland and CRH. And the coating surface keeps well in the humidity resistance after 4000 hours, as shown in FIG. 1 which is the result of E2-Cleveland Test for 4000 H.

The testing results of Comparative Example show that the physical properties of the coating composition met the technical index, while a large number of bubbles on the coating surface appeared after 250 hours in the humidity resistance test, as shown in the FIG. 2, which is the result of CE-Cleveland Test for 250 H.

1. A coating composition, comprising:
a waterborne polyvinyl fluoride dispersion selected from one or more of PVDF homopolymer dispersions and acrylic modified PVDF polymer dispersions,
wherein if the waterborne polyvinyl fluoride dispersion is a PVDF homopolymer dispersion, the composition further comprises a waterborne carboxyl acrylic resin, and
a crosslinking agent.

2. The coating composition of claim 1, further comprising:
20 to 80 parts by solid weight of a waterborne polyvinyl fluoride dispersion selected from one or more of PVDF homopolymer dispersions,
5 to 60 parts by weight of a waterborne carboxyl acrylic resin, and
1 to 20 parts by weight of a crosslinking agent, based on 100 parts by weight of total solid content.

3. The coating composition of claim 1, wherein a ratio between the solid weight of waterborne polyvinyl fluoride dispersion and the total solid weight of waterborne carboxyl acrylic resin and crosslinking agent is not less than 7:3.

4. The coating composition of claim 1, wherein a solid weight ratio between the waterborne carboxyl acrylic resin and the crosslinking agent is from 100:1 to 10:3.

5. The coating composition of claim 1, further comprising:
20 to 80 parts by solid weight of a waterborne polyvinyl fluoride dispersion selected from one or more of acrylic modified PVDF polymer dispersions, and
1 to 20 parts by weight of a crosslinking agent, based on 100 parts by weight of total solid content.

6. The coating composition of claim 1, wherein a ratio between the solid weight of waterborne polyvinyl fluoride dispersion and the solid weight of crosslinking agent is not less than 7:3.

7. The coating composition of claim 1, wherein the crosslinking agent is selected from amino resins, epoxy silanes, and blocked isocyanates.

8. The coating composition of claim 7, wherein the amino resins are selected from highly methylated melamines, partially methylated melamines, methylated high imino melamines, and butylated melamines.

9. A method for preparing a coating composition, comprising a step of mixing the following components:
a waterborne polyvinyl fluoride dispersion selected from one or more of PVDF homopolymer dispersions and acrylic modified PVDF polymer dispersions,
wherein if the waterborne polyvinyl fluoride dispersion is a PVDF homopolymer dispersion, the method further comprises a step of mixing a waterborne carboxyl acrylic resin into the composition, and
a crosslinking agent.

10. The method of claim 9, further comprising a step of mixing the following components:
20 to 80 parts by solid weight of a waterborne polyvinyl fluoride dispersion selected from one or more of PVDF homopolymer dispersions,
5 to 60 parts by weight of a waterborne carboxyl acrylic resin, and
1 to 20 parts by weight of a crosslinking agent, based on 100 parts by weight of total solid content.

11. The method of claim 9, further comprising a step of mixing the following components:
20 to 80 parts by solid weight of a waterborne polyvinyl fluoride dispersion selected from one or more of acrylic modified PVDF polymer dispersions, and
1 to 20 parts by weight of a crosslinking agent, based on 100 parts by weight of total solid content.

12. (canceled)

13. A coated substrate comprising:
a sub strate;
a coating disposed on the substrate, the coating comprising:
a waterborne polyvinyl fluoride dispersion selected from one or more of PVDF homopolymer dispersions and acrylic modified PVDF polymer dispersions;
wherein if the waterborne polyvinyl fluoride dispersion is a PVDF homopolymer dispersion, the composition further comprises a waterborne carboxyl acrylic resin; and
a crosslinking agent.

14. The coated substrate of claim 13, wherein the substrate comprises aluminum, steel, anodized aluminum oxide, or aluminum-magnesium alloy.

15. The coated substrate of claim 13, further comprising:
20 to 80 parts by solid weight of a waterborne polyvinyl fluoride dispersion selected from one or more of PVDF homopolymer dispersions;
5 to 60 parts by weight of a waterborne carboxyl acrylic resin, and
1 to 20 parts by weight of a crosslinking agent, based on 100 parts by weight of total solid content.

16. The coated substrate of claim 13, wherein a ratio between the solid weight of waterborne polyvinyl fluoride dispersion and the total solid weight of waterborne carboxyl acrylic resin and crosslinking agent is not less than 7:3.

17. The coated substrate of claim 13, wherein a solid weight ratio between the waterborne carboxyl acrylic resin and the crosslinking agent is from 100:1 to 10:3.

18. The coated substrate of claim 13, further comprising:
20 to 80 parts by solid weight of a waterborne polyvinyl fluoride dispersion selected from one or more of acrylic modified PVDF polymer dispersions; and
1 to 20 parts by weight of a crosslinking agent, based on 100 parts by weight of total solid content.

19. The coated substrate of claim 13, wherein a ratio between the solid weight of waterborne polyvinyl fluoride dispersion and the solid weight of crosslinking agent is not less than 7:3.

20. The coated substrate of claim 13, wherein the crosslinking agent is selected from amino resins, epoxy silanes, and blocked isocyanates.

21. The coated substrate of claim 20, wherein the crosslinking agent is selected from amino resins, epoxy silanes, and blocked isocyanates.
